(19) United States
(12) Patent Application Publication
(10) Pub. No.: US 2023/0415769 A1
(43) Pub. Date: Dec. 28, 2023

(54) METHOD, DEVICE, AND VEHICLE FOR COLLECTING VEHICLE DATA FOR AUTONOMOUS DRIVING

(71) Applicant: Electronics and Telecommunications Research Institute, Daejeon (KR)

(72) Inventor: Taeg Hyun AN, Daejeon (KR)

(73) Assignee: Electronics and Telecommunications Research Institute, Daejeon (KR)

(21) Appl. No.: 18/100,918

(22) Filed: Jan. 24, 2023

(30) Foreign Application Priority Data
Jun. 28, 2022 (KR) 10-2022-0078847

(51) Int. Cl. B60W 60/00

(52) U.S. Cl. CPC B60W 60/001; B60W 2420/42; B60W 2552/53

(57) ABSTRACT

Disclosed are a method, a device, and a vehicle for collecting vehicle data for autonomous driving. The method of collecting vehicle data includes: acquiring sensor data around a vehicle; outputting a recognition redundancy value based on training data that is based on the acquired sensor data and previously accumulated sensor data; receiving a unique situation message from a peripheral device; determining whether to collect driving data including the acquired sensor data based on the recognition redundancy value and the unique situation message; and collecting and managing the driving data in response to the collection of the driving data.

### CROSS-REFERENCE TO RELATED APPLICATION

This application claims priority to and the benefit of Korean Patent Application No. 10-2022-0078847, filed on Jun. 28, 2022, the disclosure of which is incorporated herein by reference in its entirety.

### BACKGROUND

### 1. Field of the Invention

The present disclosure relates to a method, a device, and a vehicle for collecting vehicle data for autonomous driving, and more particularly, to a method, a device, and a vehicle for collecting vehicle data for autonomous driving that reduces resource burden and contributes to learning improvement by collecting meaningful data that is not redundant among data acquired from a vehicle and its peripheral devices.

### 2. Discussion of Related Art

As deep learning technologies that are easy to produce precise results develop, the demand for data used for learning is increasing.

Autonomous driving vehicles are equipped with various sensors necessary for recognizing surrounding situations. Example of such sensors may include multiple cameras, multiple light detection and ranging (LiDAR) sensors, multiple radar sensors, etc. For example, when information from all sensors is stored at 20 to 30 frames per second (fps), which are the standard for real-time, a vast amount of storage space in units of tera bytes (TB) is required even if driving record of 1 hour is stored.

In order to use the stored data for actual learning, an annotation task that links true values is required. Recently, efficiency has been increased through semi-automation, but the annotation task that links the true values eventually requires handwork.

Much of the vast amount of data described above is redundant. For example, when a vehicle stops at an intersection for 1 minute and takes pictures at 30 fps with one camera during the stopped time, 30×60=1800 images are acquired, and about 1700 or more of the images may have redundant information. Since the above-described example is limited to one camera sensor, when a plurality of sensors are actually mounted on a vehicle, the amount of redundant data of a plurality of sensors rapidly increases. The annotation task on such redundant data entails enormous human resources, hardware resources, and effort, which causes waste of resources.

### SUMMARY OF THE INVENTION

The present disclosure is directed to providing a method, a device, and a vehicle for collecting vehicle data for autonomous driving that reduces resource burden and contributes to learning improvement by collecting meaningful data that is not redundant among data acquired from a vehicle and its peripheral devices.

The technical problems of the present disclosure are not limited to the above-described technical problems. That is, other technical problems that are not described may be obviously understood by those skilled in the art to which the present disclosure pertains from the following description.

According to an aspect of the present invention, there is provided a method of collecting vehicle data for autonomous driving, including: acquiring sensor data around a vehicle; outputting a recognition redundancy value based on training data that is based on the acquired sensor data and previously accumulated sensor data; receiving a unique situation message from a peripheral device; determining whether to collect driving data including the acquired sensor data based on the recognition redundancy value and the unique situation message; and collecting and managing the driving data in response to the collection of the driving data.

The sensor data may include at least one of two-dimensional and three-dimensional image data related to a situation around the vehicle.

The outputting of the recognition redundancy value may be performed using an artificial neural network that calculates recognition redundancy.

The sensor data in the outputting of the recognition redundancy value may be composed of a plurality of types of sensor data acquired in the same time interval.

The recognition redundancy value may be output as a detailed redundancy value for each object type recognized around the vehicle.

The object type may include at least one of an object recognized as a drivable area of the vehicle, a road marking object around the vehicle, a marker around the vehicle, and a landmark object around the vehicle.

The unique situation message may be composed of a message notifying whether a unique situation occurs around the vehicle based on the sensor data of the peripheral device.

When the situation occurring around the vehicle is determined to be at least one of a traffic disturbance, a risk concern event, and an accident, the unique situation message may be configured to include the occurrence of the unique situation and the type related to the occurring situation by the peripheral device.

The driving data may include control data for controlling an operation of the vehicle and a function of a component of the vehicle and state data related to a state of the vehicle along with the sensor data.

The peripheral device may be a device that performs vehicle to everything (V2X) communication and include at least one of other vehicles, a drone, and a road side unit (RSU) around the vehicle.

According to another aspect of the present invention, there is provided a device for collecting vehicle data for autonomous driving, including: a sensor unit configured to detect a surrounding environment; a memory configured to store at least one instruction; and a processor configured to execute the at least one instruction stored in the memory, in which the processor acquires sensor data around a vehicle, outputs a recognition redundancy value based on training data that is based on the acquired sensor data and previously accumulated sensor data, receives a unique situation message from a peripheral device, determines whether to collect driving data including the acquired sensor data based on the recognition redundancy value and the unique situation message, and collects and manages the driving data in response to the collection of the driving data.

According to still another aspect of the present invention, there is provided a vehicle, including: a sensor unit configured to detect a surrounding environment; a driving unit configured to perform driving; a memory configured to store at least one instruction; and a processor configured to execute the at least one instruction stored in the memory and control the driving unit, in which the processor acquires sensor data around the vehicle, outputs a recognition redundancy value based on training data that is based on the acquired sensor data and previously accumulated sensor data, receives a unique situation message from a peripheral device, determines whether to collect driving data including the acquired sensor data based on the recognition redundancy value and the unique situation message, and collects and manages the driving data in response to the collection of the driving data.

The features briefly summarized above with respect to the present disclosure are merely exemplary aspects of the detailed description of the disclosure to be described below and do not limit the scope of the disclosure.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exemplary diagram illustrating a system to which a method of collecting vehicle data for autonomous driving according to an embodiment of the present disclosure is applied;

FIG. 2 is a configuration diagram of an autonomous driving vehicle equipped with a device for collecting vehicle data for autonomous driving according to an embodiment of the present disclosure;

FIG. 3 is a diagram illustrating a model for outputting a recognition redundancy value; and

FIG. 4 is a flowchart for a method of collecting vehicle data for autonomous driving according to an embodiment of the present disclosure.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, embodiments of the present disclosure will be described with reference to the accompanying drawings.

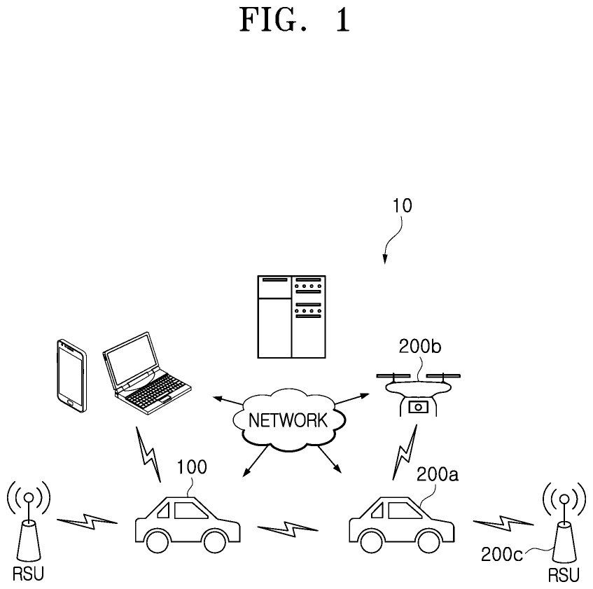

FIG. 1 is an exemplary diagram illustrating a system to which a method of collecting vehicle data for autonomous driving according to an embodiment of the present disclosure is applied. In the present disclosure, a system 10 is a system for collecting vehicle data for autonomous driving, and may include a vehicle 100, a peripheral device 200, a network, and user devices that communicate with the vehicle 100, the peripheral device 200, and the network to receive various types of information and functions from the vehicle 100 and the peripheral device 200.

Referring to FIG. 1, the vehicle 100 may communicate with the peripheral device 200 or other devices. The vehicle 100 may refer to a movable device as a means of transporting a user. The vehicle may be a four-wheeled vehicle such as a passenger car, a sport utility vehicle (SUV), or a moving device capable of loading cargo, and may be a vehicle having more than four wheels such as a large truck, a container transport vehicle, a heavy equipment vehicle, and the like, but is not limited thereto. The vehicle 100 may be implemented as a manned driving or autonomous driving (including semi-autonomous and fully autonomous driving) vehicle. In the present disclosure, for convenience of description, an example of the vehicle 100 that is an autonomous driving vehicle will be described.

Meanwhile, the vehicle 100 may perform vehicle to everything (V2X) communication with the peripheral device 200. The vehicle 100 may communicate with another vehicle 200a, another device, or an external server based on cellular communication, wave communication, dedicated short range communication (DSRC), or other communication schemes. Other devices may include, for example, at least one of a drone 200b remotely controlled by an administrator or operated autonomously and a transportation infrastructure such as a road side unit (RSU) 200c. As a cellular communication network, communication networks such as long term evolution (LTE) and 5^{th} generation (5G), a WiFi communication network, a wave communication network, and the like may be used. In addition, a local area network used in a vehicle, such as DSRC, may be used, and is not limited to the above-described embodiment.

Also, as an example, in relation to vehicle communication, a module capable of communication with a user device and a module capable of communication with an external server may be present separately for vehicle security. For example, a vehicle may perform communication based on security only with a device within a certain range of the vehicle, such as Bluetooth or near field communication (NFC). For example, a vehicle and a user's personally owned device may include a communication module for performing mutual communication only. That is, the vehicle and the user's personally owned device may use a communication network blocked from an external communication network. Also, as an example, the vehicle may include a communication module that communicates with an external server. Also, as an example, the above-described module may be implemented as one module. That is, the vehicle may communicate with other devices through one module, and is not limited to the above-described embodiment. That is, the communication method in the vehicle may be implemented based on various methods, and is not limited to the above-described embodiment.

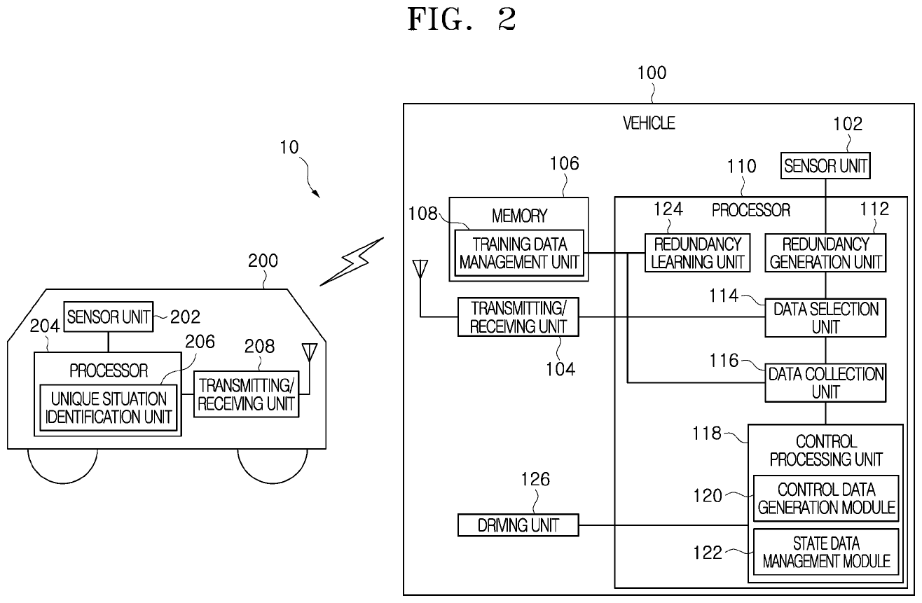

FIG. 2 is a configuration diagram of a vehicle equipped with a device for collecting vehicle data for autonomous driving according to an embodiment of the present disclosure. In the present disclosure, for convenience of description, the peripheral device 200 communicating with the vehicle 100 is illustrated as another vehicle, but the peripheral device 200 may be the drone 200b, the road side unit 200c, and the like described in FIG. 1. The vehicle 100 may include components illustrated in relation to the peripheral device 200 in order to transmit a unique situation message to another vehicle exemplified by the peripheral device 200. In addition, when the peripheral device 200 is a vehicle, the peripheral device 200 may also have components illustrated in relation to the vehicle 100 in order to exclude redundant driving data.

The vehicle 100 is an autonomous driving mobile body, and may collect, in real time, driving data that includes sensor data for detecting various situations around the vehicle 100 while driving, state data for components of the vehicle 100 generated while driving, control data instructing the components to perform operations required for the vehicle 100, and the like. To this end, the vehicle 100 may include a device for collecting data for autonomous driving according to the embodiment of the present disclosure.

Specifically, the vehicle 100 may include a sensor unit 102, a transmitting/receiving unit 104, a memory 106, a driving unit 126, and a processor 110. The above-described elements may form the device for collecting data for autonomous driving according to the present embodiment.

The sensor unit 102 may include various sensor modules mounted on the vehicle 100. The sensor unit 102 may include a sensor for acquiring at least one of two-dimensional (2D) and three-dimensional (3D) image data through which a situation around the vehicle 100 can be recognized, a positioning sensor, a sensor for measuring attitude and orientation of the vehicle 100, a distance sensor, a collision sensor, etc., but is not limited thereto. The sensor for acquiring the 2D and 3D image data may include, for example, at least one of a camera sensor, a light detection and ranging (LiDAR) sensor, and a radar sensor. The sensor unit 102 may periodically acquire sensor data that is raw data.

The transmitting/receiving unit 104 may include a module that supports communication with the peripheral device 200, for example, V2X communication, and receive sensor data acquired through the sensor unit 102 of the peripheral device 200, a unique situation message, and the like.

The memory 106 may store a program or an application for executing the method of collecting vehicle data for autonomous driving according to an embodiment of the present disclosure, and the processor 110 may call and execute the program or the like from the memory 106. The memory 106 may store driving data generated from past driving of the vehicle 100 according to various situations. The memory 106 may use a training data management unit 108 to manage, as training data, driving data on which annotation task has been performed for each situation. The training data may be generated from the vehicle 100 or received from an external device.

The driving unit 126 is a component installed in the vehicle 100 for driving and convenience, and may be, for example, an actuator that implements various operations necessary for the vehicle 100. The driving unit 126 may include a power system, a steering system, an energy management system, and the like for driving the vehicle 100. In addition, the driving unit 126 may include a lighting system required for safe driving, a cooling system, and an air conditioning system for convenience. The driving unit 126 may be controlled using control data of the processor 110 based on user instructions or settings of the processor 110.

The processor 110 may include a redundancy generation unit 112, a data learning unit 114, a data collection unit 116, a control processing unit 118, and a redundancy learning unit 124.

The redundancy generation unit 112 may output a recognition redundancy value based on the sensor data acquired from the sensor unit 102 and the training data processed for the previously accumulated sensor data using the redundancy learning unit 124.

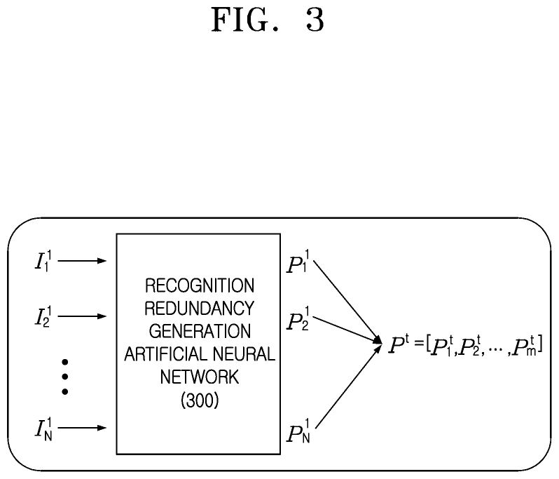

FIG. 3 is a diagram illustrating a model for outputting a recognition redundancy value.

A recognition redundancy value may be output using an artificial neural network that calculates recognition redundancy. Sensor data input to calculate the recognition redundancy value may be composed of a plurality of types of sensor data acquired at the same time interval.

As a detailed description with reference to FIG. 3 as an example, the raw data acquired from the sensor unit 102 at time t may be Iₙ^{t} (n=image, individual sensing information such as LiDAR, radar), and the recognition redundancy may be P^{t}=[p₁^{t}, p₂^{t}, . . . , pₘ^{t}]. pₘ^{t} may be the recognition redundancy for an m^{th} recognition type acquired from raw data at time t.

That is, the recognition redundancy value may be output as a detailed redundancy value for each object type recognized around the vehicle 100. The object type may include at least one of an object recognized as a drivable area of the vehicle 100, a road marking object around the vehicle 100, a marker around the vehicle 100, and a landmark object around the vehicle 100. The above-described m may be a recognition type for the surrounding environment such as drivable area recognition, object recognition, traffic lane recognition, and marker recognition. When defined as such, the redundancy generation unit 112 may generate redundancy by a recognition redundancy generation artificial neural network 200 illustrated in FIG. 3.

More specifically, the sensor unit 102 may include a plurality of camera sensors and LiDAR sensors disposed in various locations of the vehicle 100. The plurality of camera sensors may each acquire a plurality of pieces of secondary image data at the same time t. The LiDAR sensor may acquire a plurality of pieces of 3D image data at the same time t. The 2D and 3D image data acquired at the same time t may be used as an input of a recognition redundancy calculation.

The image data input at time t may be analyzed along with training data received from the training data management unit 108 in the artificial neural network, for example, training data based on previously accumulated homogeneous/heterogeneous sensor data. The training data may be selected as data including, for example, the same location and/or object type as the input image data. For example, when the input image data includes a plurality of landmark objects distinguished from each other as an object type and a plurality of driving area objects recognized as a drivable area, the training data may also be selected to include the objects.

The recognition redundancy calculation may match the input image data and the training data with each other using a plurality of identical objects, and derive each value for each landmark object (e.g., p₁^{t}, p₂^{t}, . . . , pₖ^{t}) and driving area object (e.g., pₖ₊₁^{t}, pₖ₊₂^{t}, . . . , pₘ^{t}). Based on each derived value, overall redundancy of the input data may be evaluated or detailed redundancy may be calculated for each object. The recognition redundancy value may be a value including at least one of the overall redundancy and the detailed redundancy.

The data learning unit 114 may determine whether to collect driving data including the acquired sensor data based on the unique situation message received from the peripheral device 200 and the recognition redundancy value. The driving data may include, for example, control data for controlling the operation of the vehicle 100 and functions of components of the vehicle 100, and state data related to the state of the vehicle 100, along with the sensor data.

The control and state data may be generated and managed in the control processing unit 118 that manages vehicle control and various states. The control data is generated by the control data generation module 120, and the state data generated by recognizing the state of the component may be managed by the state data management module 122.

The control and state data are not used for the redundancy calculation performed in the redundancy generation unit 112 and may be the remaining data necessary for driving. The control and state data may include data for operating the driving unit 126 and data indicating the state of the components of the vehicle 100 according to the driving. For example, the control and state data may include Controller Area Network (CAN) information necessary for vehicle control, Global Positioning System (GPS)/Inertial Measurement Unit (IMU) information indicating a current location of the vehicle, navigation information, and the like. The control and state data may be used for determination and control in addition to the recognition necessary for autonomous driving in the future.

The data collection unit 116 may collect and manage the driving data when the data learning unit 114 determines that it is necessary to collect the driving data. The data collection unit 116 selects and stores data acquired from the sensor unit 101 and the control processing unit 118 based on the input indicated by the data learning unit 114.

The data collection unit 116 may select and store the sensor data of the peripheral device 200 acquired through the transmitting/receiving unit 104 in some cases. After further refinement and annotation tasks are performed on the collected data, the annotated data may be added to the training data management unit 108. In addition, the training data is transmitted to the redundancy learning unit 124, the redundancy learning unit 124 may train vehicle control processing suitable for the unique situation based on the training data associated with the unique situation, and when the unique situation occurs again, the information associated with the trained control processing may be provided to a vehicle control unit (VCU) of the processor 110 or the like.

Meanwhile, the peripheral device 200 may include a transmitting/receiving unit 208 that transmits a unique situation message by supporting the V2X communication with the sensor unit 202, the processor 110, and the vehicle 100.

The sensor unit 202 may be configured similarly to the sensor unit 102 of the vehicle 100. The processor 110 may include a unique situation identification unit 206 that generates a unique situation message notifying whether a unique situation has occurred by identifying whether the unique situation has occurred around the vehicle 100 based on the sensor data of the peripheral device. When the unique situation identification unit 206 determines that the situation occurring around the vehicle 100 is at least one type of a traffic disturbance, a risk concern event, and an accident, the unique situation identification unit 206 may generate a unique situation message to include the occurrence of the unique situation and all types related to the occurring situation. The unique situation may be, for example, an accident, construction, congestion, jaywalking, etc., but may vary without being limited thereto.

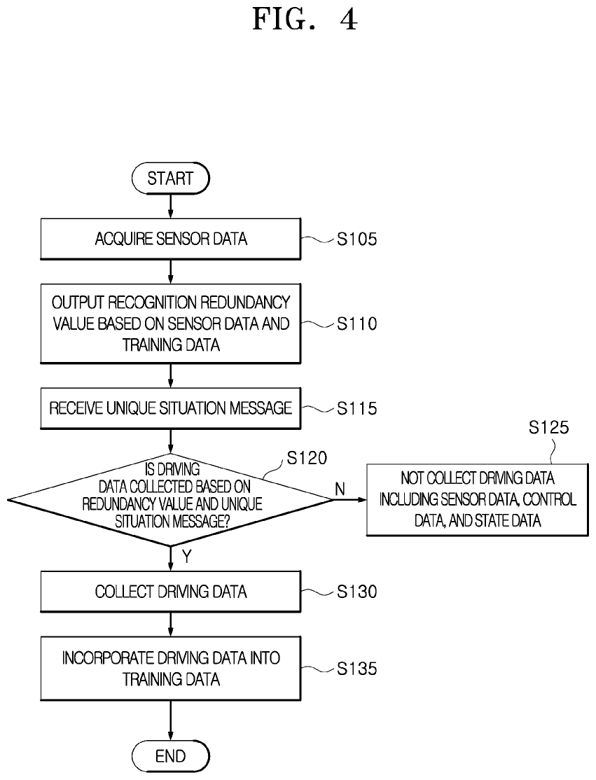

Hereinafter, a method of collecting vehicle data for autonomous driving according to another embodiment of the present disclosure will be described with reference to FIGS. 1 to 4. FIG. 4 is a flowchart for a method of collecting vehicle data for autonomous driving according to an embodiment of the present disclosure. In the present disclosure, examples of the vehicle and peripheral devices according to FIGS. 2 and 3 will be described.

First, the vehicle 100 may acquire at least one sensor data among 2D and 3D image data capable of recognizing a surrounding situation from the sensor unit 102 (S105).

The redundancy generation unit 112 may output the recognition redundancy value based on the acquired sensor data and the training data based on the previously accumulated sensor data in the training data management unit 108 (S110).

Specifically, a recognition redundancy value may be calculated using the artificial neural network that calculates the recognition redundancy illustrated in FIG. 3. Sensor data input to the artificial neural network may be composed of a plurality of types of sensor data acquired at the same time interval. The recognition redundancy value may be output as a detailed redundancy value for each object type recognized around the vehicle 100. The object type may include at least one of the object recognized as the drivable area of the vehicle 100, the road marking object around the vehicle 100, the marker around the vehicle 100, and the landmark object around the vehicle 100. A detailed description thereof will be omitted because it has been described with reference to FIG. 3.

Next, the data learning unit 114 may receive a unique situation message from the peripheral device 200 (S115).

The unique situation message may be composed of a message notifying whether the unique situation occurs around the vehicle 100 based on the sensor data of the peripheral device 200. When the situation occurring around the vehicle is determined to be at least one of a traffic disturbance, a risk concern event, and an accident, the unique situation message may include the occurrence of the unique situation and the type related to the occurring situation by the peripheral device 200.

Next, the data learning unit 114 may determine whether to collect the driving data including the acquired sensor data based on the recognition redundancy value and the unique situation message received from the peripheral device 200 (S120).

For example, the data learning unit 114 may confirm whether the unique situation message is notified that there is no unique situation at the time of acquisition of the sensor data used for calculating the recognition redundancy value. In addition, the data learning unit 114 may check whether various types of sensor data have redundancy with a predetermined reference value or greater in the recognition redundancy value.

When it is confirmed that the unique situation message is notified that there is no unique situation and various types of sensor data have redundancy with the recognition redundancy value which is the predetermined reference value, the data learning unit 114 may control the data collection unit 116 not to collect the driving data. In addition, the data collection unit 116 may not store the driving data in the memory 106 or the training data management unit 108 (S125). As described above, the driving data may include the control data for controlling the operation of the vehicle 100 and the functions of the components of the vehicle 100, and the state data related to the state of the vehicle 100, along with the sensor data.

In contrast, when the unique situation message notifies that there is a unique situation when there is redundancy of the sensor data, or that there is no redundancy of sensor data when there is no notification of a unique situation, the data learning unit 114 may determine that there is a need to collect or store driving data acquired at a predetermined time interval. In response to this determination, the data collection unit 116 may collect the driving data (S130), and incorporate the collected driving data into the training data (S135), thereby managing and controlling the training data.

Since the unique situations do not occur frequently, normal driving data is highly unlikely to be related to the unique situation, and the possibility that there is a unique situation in normal training data is very low. Therefore, the recognition rate for the driving data or training data when the unique situation occurs may be low. The probability that the information related to the situation is present before and after the occurrence of the unique situation is very high, but it is often difficult to accurately recognize the situation at a location of one's own vehicle. According to the embodiment of the present disclosure, prior to identifying the corresponding event in one's own vehicle, the vehicle may selectively acquire meaningful data by being notified of the unique situation through the V2X communication with the peripheral devices. In addition, it is possible to reduce the resource burden by collecting the meaningful data, and drastically reduce the amount of annotation task to contribute to the learning improvement.

Exemplary methods of the present disclosure are expressed as a series of operations for clarity of explanation, but this is not intended to limit the order in which steps are performed, and each step may be performed simultaneously or in a different order, if necessary. In order to implement the method according to the present disclosure, other steps may be included in addition to the exemplified steps, some steps may be omitted and the rest included, or some steps may be omitted with other additional steps included.

Various embodiments of the present disclosure are intended to explain representative aspects of the present disclosure, rather than listing all possible combinations, and matters described in various embodiments may be applied independently or in combination of two or more.

In addition, various embodiments of the present disclosure may be implemented by hardware, firmware, software, a combination thereof, or the like. For implementation by hardware, various embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

According to a method, device, and vehicle for collecting vehicle data for autonomous driving according to the present disclosure, it is possible to reduce resource burden and contribute to learning improvement by collecting meaningful data that is not redundant among data acquired from a vehicle and its peripheral devices.

Specifically, according to the present disclosure, when data is collected for autonomous driving, it is possible to selectively store driving data by calculating redundancy of recognition data and whether unique situations occurs based on sensor data acquired from a recognition sensor of a vehicle and sensors of peripheral devices. Accordingly, it is possible to prevent redundant data from unnecessarily occupying a memory of a vehicle, and even when the redundant data is used as training data later, supplement image data that is not clearly recognized by the existing recognition system.

Exemplary methods of this disclosure are presented as a series of operations for clarity of explanation, but this is not intended to limit the order in which steps are performed, and each step may be performed concurrently or in a different order, as necessary. In order to implement the method according to the present disclosure, other steps may be included in addition to the exemplified steps, other steps may be included except for some steps, or additional other steps may be included except for some steps.

Various embodiments of the present disclosure are intended to explain representative aspects of the present disclosure rather than listing all possible combinations, and details described in various embodiments may be applied independently or in combination of two or more.

In addition, various embodiments of the present disclosure may be implemented by hardware, firmware, software, or a combination thereof. For implementation by hardware may be performed by one or more application specific integrated circuits (ASICs), digital signal processors (DSPs), digital signal processing devices (DSPDs), programmable logic devices (PLDs), field programmable gate arrays (FPGAs), a general processor, a controller, a microprocessor, and the like.

The scope of the present disclosure includes software or machine-executable instructions (e.g., operating system, applications, firmware, programs, etc.) that cause operations according to the method according to various embodiments to be executed on a device or computer, and a non-transitory computer-readable medium in which such software or instructions are stored and executable on the device or computer.

What is claimed is:

1. A method of collecting vehicle data for autonomous driving, comprising:
acquiring sensor data around a vehicle;
outputting a recognition redundancy value based on training data that is based on the acquired sensor data and previously accumulated sensor data;
receiving a unique situation message from a peripheral device;
determining whether to collect driving data including the acquired sensor data based on the recognition redundancy value and the unique situation message; and
collecting and managing the driving data in response to the collection of the driving data

2. The method of claim 1, wherein the sensor data includes at least one of two-dimensional and three-dimensional image data related to a situation around the vehicle.

3. The method of claim 1, wherein the outputting of the recognition redundancy value is performed using an artificial neural network that calculates recognition redundancy.

4. The method of claim 1, wherein the sensor data in the outputting of the recognition redundancy value is composed of a plurality of types of sensor data acquired in the same time interval.

5. The method of claim 1, wherein the recognition redundancy value is output as a detailed redundancy value for each object type recognized around the vehicle.

6. The method of claim 5, wherein the object type includes at least one of an object recognized as a drivable area of the vehicle, a road marking object around the vehicle, a marker around the vehicle, and a landmark object around the vehicle.

7. The method of claim 1, wherein the unique situation message is composed of a message notifying whether a unique situation occurs around the vehicle based on the sensor data of the peripheral device.

8. The method of claim 7, wherein, when the situation occurring around the vehicle is determined to be at least one of a traffic disturbance, a risk concern event, and an accident, the unique situation message is configured to include the occurrence of the unique situation and the type related to the occurring situation by the peripheral device.

9. The method of claim 1, wherein the driving data includes control data for controlling an operation of the vehicle and a function of a component of the vehicle and state data related to a state of the vehicle along with the sensor data.

10. The method of claim 1, wherein the peripheral device is a device that performs vehicle to everything (V2X) communication and includes at least one of other vehicles, a drone, and a road side unit (RSU) around the vehicle.

11. A device for collecting vehicle data for autonomous driving, comprising:
a sensor unit configured to detect a surrounding environment; and
a processor configured to execute at least one instruction stored in a memory,
wherein the processor acquires sensor data around a vehicle,
outputs a recognition redundancy value based on training data that is based on the acquired sensor data and previously accumulated sensor data,
receives a unique situation message from a peripheral device,
determines whether to collect driving data including the acquired sensor data based on the recognition redundancy value and the unique situation message, and
collects and manages the driving data in response to the collection of the driving data.

12. The device of claim 11, wherein the sensor data includes at least one of two-dimensional and three-dimensional image data related to a situation around the vehicle.

13. The device of claim 11, wherein outputting of the recognition redundancy value is performed using an artificial neural network that calculates recognition redundancy.

14. The device of claim 11, wherein the sensor data when the recognition redundancy value is output is composed of a plurality of types of sensor data acquired in the same time interval.

15. The device of claim 11, wherein the recognition redundancy value is output as a detailed redundancy value for each object type recognized around the vehicle.

16. The device of claim 15, wherein the object type includes at least one of an object recognized as a drivable area of the vehicle, a road marking object around the vehicle, a marker around the vehicle, and a landmark object around the vehicle.

17. The device of claim 11, wherein the unique situation message is composed of a message notifying whether a unique situation occurs around the vehicle based on the sensor data of the peripheral device.

18. The device of claim 17, wherein, when the situation occurring around the vehicle is determined to be at least one of a traffic disturbance, a risk concern event, and an accident, the unique situation message is configured to include the occurrence of the unique situation and the type related to the occurring situation by the peripheral device.

19. The device of claim 11, wherein the driving data includes control data for controlling an operation of the vehicle and a function of a component of the vehicle and state data related to a state of the vehicle along with the sensor data.

20. A vehicle comprising:
a sensor unit configured to detect a surrounding environment;
a driving unit configured to perform driving; and
a processor configured to execute the at least one instruction stored in a memory and control the driving unit,
wherein the processor acquires sensor data around the vehicle,
outputs a recognition redundancy value based on training data that is based on the acquired sensor data and previously accumulated sensor data,
receives a unique situation message from a peripheral device,
determines whether to collect driving data including the acquired sensor data based on the recognition redundancy value and the unique situation message, and
collects and manages the driving data in response to the collection of the driving data.
